(19) United States
(12) Patent Application Publication
(10) Pub. No.: US 2009/0230115 A1
(43) Pub. Date: Sep. 17, 2009

(54) PEB APPARATUS AND CONTROL METHOD

(76) Inventor: Tokio Shino, Miyagi (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/395,762

(22) Filed: Mar. 2, 2009

(30) Foreign Application Priority Data
Mar. 13, 2008 (JP) 2008-064197

(51) Int. Cl. H05B 1/00; H05B 1/02

(52) U.S. Cl. 219/412; 219/492

(57) ABSTRACT

There is provided a post exposure baking apparatus that can effectively restrain the fluctuation of the size of pattern between wafers in a baking process for continuously processing a plurality of wafers as a batch sequence and a control method thereof. A baking time offset amount is set for each order number processing each wafer in the batch sequence, and a baking time of the wafer is corrected in accordance with the baking time offset amount corresponding to the processing order number in the baking process of the wafer.

### CROSS-REFERENCE TO RELATED APPLICATIONS

This application claims priority under 35 U.S.C. §119 to Japanese Patent Application Serial No. JP 2008-064197 filed on Mar. 13, 2008, entitled “PEB APPARATUS AND CONTROL METHOD,” the disclosure of which is hereby incorporated by reference.

### RELATED ART

1. Field of the Invention

The disclosure relates to a post exposure bake apparatus that bakes a semiconductor wafer on which resist materials are applied after exposure, and a control method thereof in a photolithography process of a semiconductor device.

2. Description of the Related Art

In recent years, the size of semiconductor devices has been gradually miniaturized, and a chemically-amplified resist has been widely used to fabricate such miniaturized devices. With this miniaturization, the tolerable variation for every wafer pattern decreases, as well as variations tolerable from resist application to exposure (post coating delay, “PCD”) and from exposure to development (post exposure delay, “PED”) has drastically decreased.

Japanese Patent Application Laid-Open No. 1996-111370 discloses a technique by which fluctuation of the size of a resist pattern is corrected by controlling a post exposure bake process time for each wafer in the post exposure bake apparatus. However, since such a technique needs individual control for each of a plurality of wafers, this technique is not advantageous for mass production of semiconductor devices.

On the other hand, with the aim of efficient mass production of semiconductor devices, a plurality of units that perform processes of resist application on a wafer surface, development, baking, and cooling is integrated into a single resist process apparatus. Moreover, a plurality of wafers is continuously processed in the integrated resist process apparatus.

In such an integrated resist process apparatus, in order to restrain variations of pattern size between wafers, a batch sequence is adopted in which variations of pattern size between wafers can be reduced by holding constant processing times between continuously-processed wafers. In other words, a batch sequence is used, which eliminates the variation of PCD time or PED time by holding constant time charts for each wafer, such as processing times for units for performing resist application, baking, and cooling, times carrying wafers between the units, and/or waiting times.

### INTRODUCTION TO THE INVENTION

In a batch sequence for processing semiconductor wafers, in which processing times between wafers are held constant, unprocessed wafers may nevertheless have variations of pattern size. For example, as illustrated in FIG. 1, around five wafers (wafer processing order numbers: #1 to #5) from the start of the batch sequence exhibit narrower pattern size compared to subsequent wafers (wafer processing order numbers: after #6).

It is hypothesized this narrower pattern size phenomenon is caused by a delay between batch sequences. For example, as illustrated in FIG. 2, a temperature controlling mechanism of a baking unit in a waiting state (before processing the wafers) controls the temperature of the baking plate having a certain heat capacity to maintain the temperature around 100° C., approximating an equilibrium state. However, since an equilibrium state does not generally continue when one or more wafers are introduced onto the backing plate at around 23° C., the temperature controlling mechanism of the baking unit must raise the temperature to reach 100° C. for both the wafer and plate. Generally, raising the temperature by the controlling mechanism results in temperature overshoots. However, since a temperature rise occurs when the wafer is carried out of the baking unit, the temperature controlling mechanism must reduce the temperature of the plate to reach the 100° C. temperature. The temperature controlling mechanism of the baking unit repeats these temperature adjustments, raising and lowering the temperature, each time the wafer is carried in or out. Subsequently, the wafers are processed from an equilibrium temperature state in waiting before starting a batch sequence to a stable temperature state after starting the batch sequence. Although the temperature control performance is dependent upon the change of heat capacity of the baking unit, it is extremely difficult to perfectly remove time delay between maintaining the set temperature of the baking plate with the actual temperature of a baking plate.

The instant disclosure includes a method and device for providing a post exposure bake (“PEB”) apparatus that can effectively restrain fluctuations of pattern size between wafers in a baking process for continuously processing a plurality of wafers as a batch sequence. According to a first exemplary aspect of the disclosure, there is provided a PEB apparatus that sequentially bakes a plurality of wafers each carrying resist materials subjected to one batch sequence, the apparatus includes: (a) baking time offset amount setting means that sets a baking time offset amount for each order number processing the wafers in the batch sequence; and (b) baking time correcting means that corrects a baking time of each wafer in accordance with a baking time offset amount corresponding to a processing order number of each wafer during the baking process.

According to another aspect of the present disclosure, there is provided a control method in an apparatus that sequentially processes a plurality of wafers of which each carries resist materials and which is fabricated in a single batch sequence, the method includes: (a) setting a baking time offset amount for each processing order number of the wafers in the batch sequence; and (b) correcting a baking time of each wafer in accordance with a baking time offset amount corresponding to a processing order number of the each wafer when processing the wafers.

According to a PEB apparatus and a control method of the present disclosure, there is provided a configuration correcting a PEB time in accordance with the processing order number for each wafer fabricated in a batch sequence. According to this, since a baking process can be performed by correcting a PEB time about some wafers in the front part of the batch sequence and applying a constant PEB time about most of the wafers in the batch sequence, the fluctuation of the size of pattern between wafers can be effectively restrained.

It is a first aspect of the present invention to provide a post exposure bake apparatus that sequentially bakes a plurality of wafers, at least one of which carries a resist material and which is at least partially fabricated using a batch baking process, the apparatus comprising: (a) a baking apparatus; (b) a programmable controller in electrical communication with the baking apparatus, the programmable controller operative to determine a baking time offset amount for at least one of a plurality of wafers carrying a resist material in a batch sequence; and (c) an algorithm associated with the programmable controller for correcting a baking time of at least one of the plurality of wafers carrying the resist material in accordance with the baking time offset amount corresponding to a processing order number of the at least one of the plurality of wafers carrying the resist material when processing the plurality of wafers.

In a more detailed embodiment of the first aspect, the algorithm is operative to determine whether a process waiting time from a termination of a previous batch sequence to a present new batch sequence exceeds a predetermined threshold value each time the batch sequence is newly started, and the algorithm stops correction for at least one of the plurality of wafers carrying the resist material in the new batch sequence when it is determined that the process waiting time does not exceed the predetermined threshold value. In yet another more detailed embodiment, the embodiment also includes a look-up table including baking time offset amounts correlated to a plurality of different resist materials, where the controller is in electrical communication with the look-up table to extract a baking time offset amount specific to the type of resist material applied to at least one of the plurality of wafers, and where the controller corrects the baking time in accordance with the baking time offset amount specific to the type of resist material applied to at least one of the plurality of wafers of the batch sequence. In a further detailed embodiment, the baking time offset amount setting means comprises means for computing the baking time offset amount on the basis of a predetermined PEB time correction coefficient corresponding to the type of resist materials of the batch sequence every new batch sequence.

It is a second aspect of the present invention to provide a control method for an apparatus that sequentially bakes a plurality of semiconductor wafers of which at least one carries a resist material and at least partially fabricated using a batch baking process, the method comprising: (a) setting a baking time offset amount for at least the one semiconductor wafer carrying the resist material processed in the batch baking process; and, (b) correcting a baking time of at least the one semiconductor wafer in accordance with the set baking time offset amount when baking the at least one semiconductor wafer.

In a more detailed embodiment of the second aspect, the method further comprises deciding whether a process waiting time from the termination of a previous batch baking process to a new batch baking process exceeds a predetermined threshold value each time the batch backing process is newly started, where the act or correcting the backing time includes the act of stopping for the at least one semiconductor wafer in the new batch baking process when it is determined that the process waiting time does not exceed the predetermined threshold value. In yet another more detailed embodiment, the act of setting the baking time offset amount includes the act of setting a baking time offset amount for a plurality of resist materials, and the act of correcting the baking time includes correcting the baking time in accordance with a baking time offset amount corresponding specifically to at least one of the resist materials of the batch baking process. In a further detailed embodiment, the act or setting the baking time offset amount comprises computing the baking time offset amount on the basis of a predetermined post exposure bake time correction coefficient corresponding specifically to at least one of the resist materials of the batch baking process for each new batch baking process.

It is a third aspect of the present invention to provide a post exposure bake apparatus that sequentially processes a plurality of wafers, the apparatus comprising: (a) a baking time offset amount calculator that sets a baking time offset amount for a plurality of wafer batches processed in a series of batch baking processes; and (b) a baking time correction calculator calculating a baking time of each of the plurality of wafer batches in accordance with the baking time offset amount when the plurality of wafer batches are baked in the series of batch baking processes.

In a more detailed embodiment of the third aspect, the embodiment further includes a processor for determining whether a process waiting time from the termination of a previous batch baking process to the inception of a subsequent batch baking process exceeds a predetermined threshold value, and the baking time correction calculator inhibits correction for the subsequent batch baking process when the processor determines that the process waiting time does not exceed the predetermined threshold value. In yet another more detailed embodiment, the baking time offset amount calculator sets the baking time offset amount dependent upon the type of resist material applied to wafers of the plurality of wafer batches, and the baking time correction calculator determines the baking time using the baking time offset amount corresponding to the type of resist material applied to wafers of the plurality of wafer batches. In a further detailed embodiment, the baking time offset amount calculator includes a computer for computing the baking time offset amount on the basis of a predetermined post exposure bake time correction coefficient corresponding to the type of resist material applied to wafers of the plurality of wafer batches.

It is a fourth aspect of the present invention to provide a control method in an apparatus that sequentially bakes a plurality of wafers of which each carries a resist material and which is at least partially fabricated in a batch sequence, the method comprising: (a) setting a baking time offset amount for a group of wafers comprising a batch set in the batch baking sequence; and (b) correcting a baking time of for the group of wafers in accordance with a baking time offset amount.

In a more detailed embodiment of the fourth aspect, the method further includes determining whether a process waiting time from the termination of a previous baking batch sequence to a subsequent batch baking sequence exceeds a predetermined threshold value, and the baking time correcting step stops correction for the subsequent batch baking sequence when it is determined that the process waiting time does not exceed the predetermined threshold value. In yet another more detailed embodiment, the baking time offset amount setting step sets the baking time offset amount dependent upon a type of resist material coating the group of wafers of the batch set, and the baking time correcting step corrects the baking time in accordance with a baking time offset amount corresponding to the type of resist material coating the group of wafers of the batch set. In a further detailed embodiment, the baking time offset amount setting step comprises computing the baking time offset amount on the basis of a predetermined post exposure baking time correction coefficient corresponding to a type of resist material coating the group of wafers of the batch set.

### BRIEF DESCRIPTION OF THE DRAWINGS

FIG. 1 is a transition graph of the pattern size of every wafer using a method for controlling a conventional PEB apparatus.

FIG. 2 is a view illustrating changes in plate temperature within the PEB apparatus.

FIG. 3 is a block diagram illustrating an entire configuration of a PEB apparatus according to an exemplary embodiment of the disclosure.

FIG. 4 is a graph utilized in a method for obtaining a PEB time offset amount every wafer.

FIG. 5 is an exemplary setting from a parameter table corresponding to the system of FIG. 3.

FIG. 6 is a graph illustrating size pattern results as a function of PEB time in a resist of a hybrid type in accordance with the instant disclosure.

FIG. 7 is a graph illustrating size pattern results as a function of PEB time in a resist of an ESCAP type in accordance with the instant disclosure.

FIG. 8 is a graph illustrating size pattern results as a function of PEB time in a resist of an acetal type in accordance with the instant disclosure.

FIG. 9 is a schematic diagram illustrating processing procedures for a method of controlling a PEB apparatus in accordance with the instant disclosure.

FIG. 10 is a graph illustrating size pattern results obtained by executing a PEB time control method in accordance with the instant disclosure.

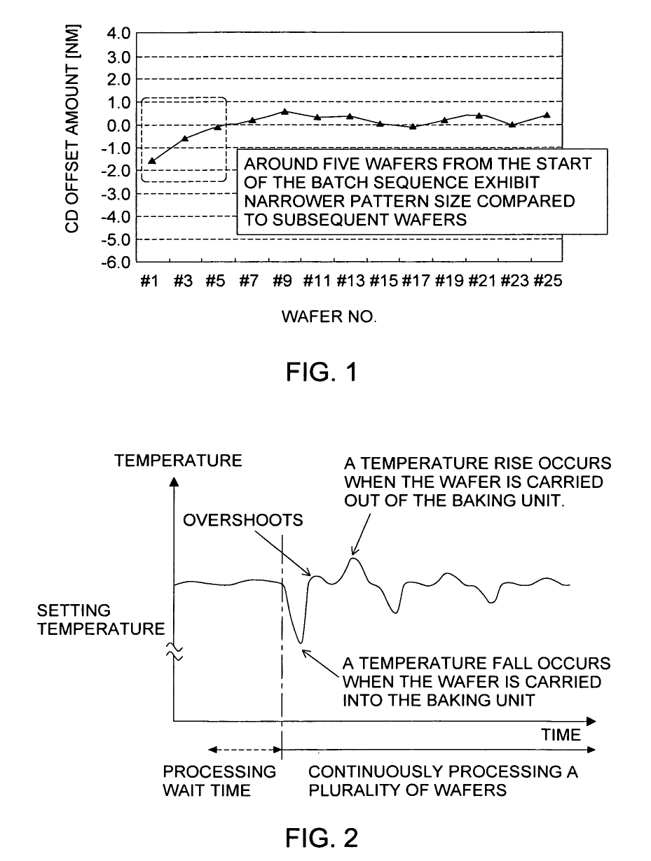

### DETAILED DESCRIPTION

The exemplary embodiments of the present invention are described and illustrated below to encompass post exposure bake apparatuses that bake a semiconductor wafer on which resist materials are applied after exposure, and a control method thereof in a photolithography process of a semiconductor device. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

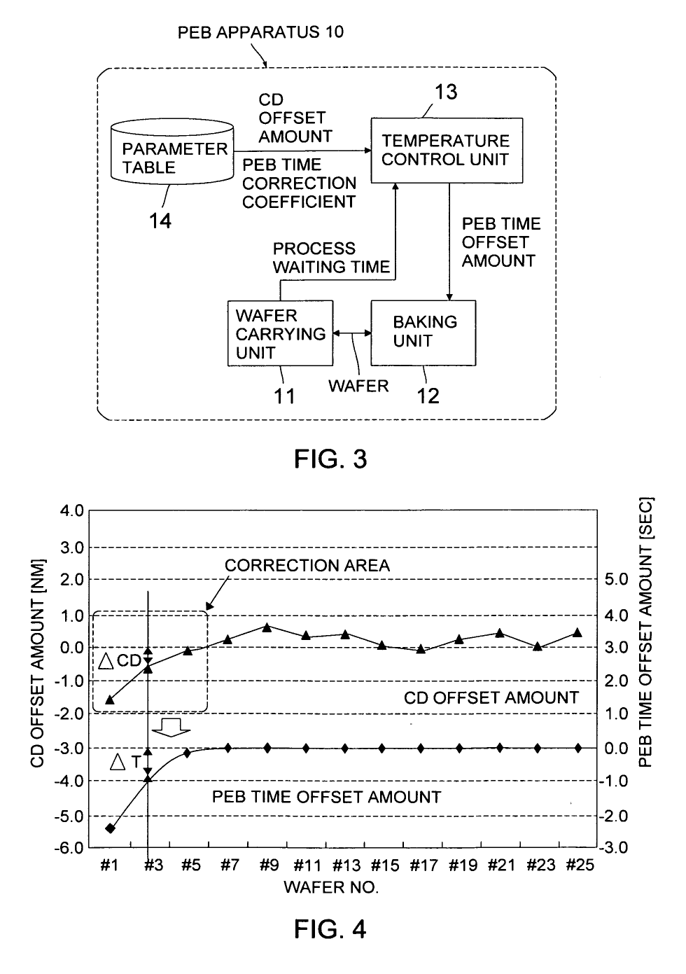

Referencing FIG. 3, an exemplary post exposure bake (“PEB”) apparatus 10 includes a wafer carrying unit 11, a baking unit 12, a temperature control unit 13, and a parameter table 14. The wafer carrying unit 11 carries in and out one or more wafers, having already been processed by an exposure apparatus after application of a resist, to the baking unit. The wafer carrying unit 11 keeps track of (i.e., counts) a process waiting time from the termination of a previous batch sequence and informs the temperature control unit 13 of the process waiting time that has been counted in response to the start of a new batch sequence. The baking unit 12 bakes or processes each wafer according to a processing order number on the basis of a PEB temperature and a PEB time from the temperature control unit 13.

In starting a batch sequence, the temperature control unit 13 retrieves directions according to the type of resist material(s) specified in the batch sequence from the parameter table 14, and calculates a post exposure processing (“PEP”) time from the obtained parameter in the baking unit 12. The parameter table 14 holds various types of parameters used for calculating a PEP time for each type of resist material(s). The PEP time comprises the combination of an average PEB time and a PEB offset time. The PEB offset time is a correction factor.

Referring to FIG. 4, when, for example, a wafer processing order number. 3 is considered with reference to FIG. 4, a critical distance (“CD”) offset (“ΔCD”) is measured as the fluctuation of pattern size. Therefore, a PEB time offset amount (“ΔT”) offsetting the ΔCD is needed. In the present embodiment, it is necessary to provide a relationship between ΔCD and ΔT at a constant ratio, namely, a PEB time correction coefficient.

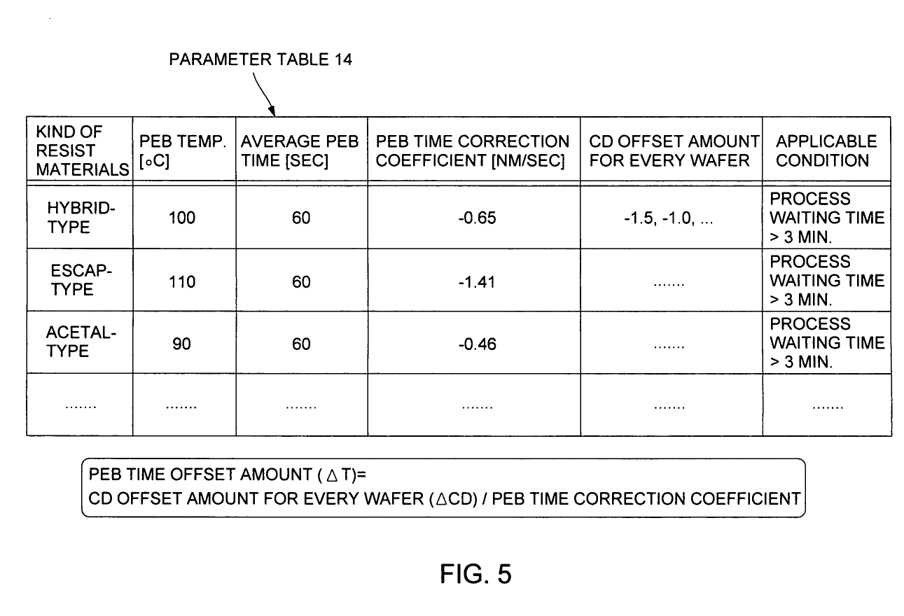

FIG. 5 illustrates an example from the parameter table 14 schematically depicted in FIG. 3. The parameter table 14 includes PEB temperature (in degrees Celsius), an average PEB time (in seconds), a PEB time correction coefficient (in nanometers/second), a CD offset amount (in nanometers) for every wafer, and an applicable condition for each resist type. The PEB temperature is the temperature input to the temperature controlling mechanism of the baking unit, and it is presumed that the temperature is constant during the batch processing sequence in the present embodiment. The average PEB time is a baking time applied to most of wafers in the batch sequence. The PEB time correction coefficient is derived from the ratio between ΔCD and Δt, and is obtained from observation results, which will be described hereafter. The CD offset amount for every wafer is a measured amount for each wafer in the batch sequence. The ΔT for every wafer is obtained from the following ratio: ΔT=ΔCD/the PEB time correction coefficient.

In this exemplary explanation, a process waiting time of greater than three minutes is set. In other words, when the process waiting time exceeds the threshold value of three minutes, a PEB time correction calculation is performed based upon the number of wafers and number of wafers per sheet being processed.

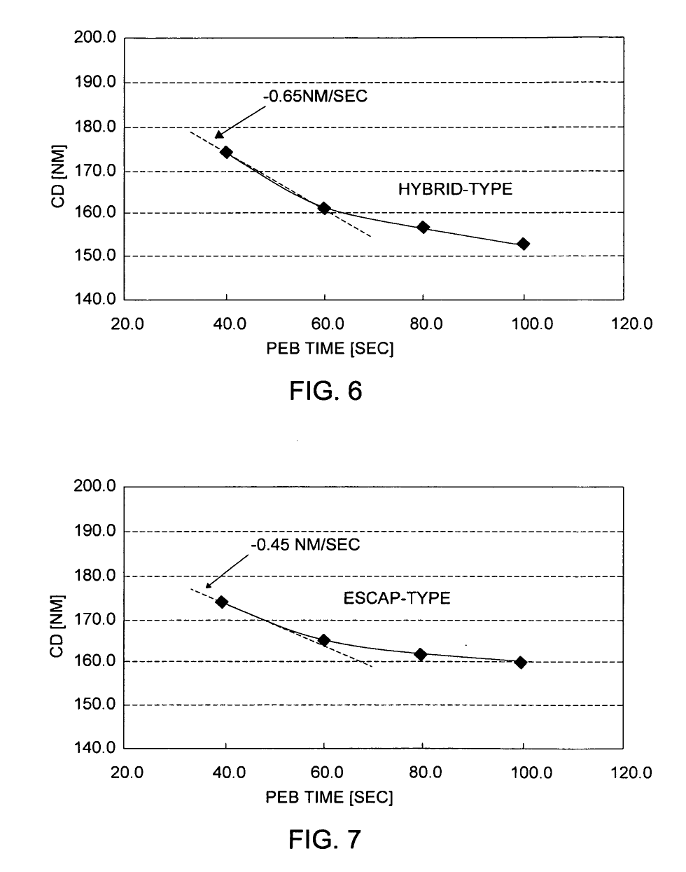

Referencing FIGS. 6-8 respectively, illustrate changes in pattern size as a function of PEB time for different resist materials. For example, referring specifically to FIG. 6, the relationship between pattern size and the PEB time is shown, with the change of the pattern size to the PEB time, that is to say, the ratio of change in pattern size as a function of time between forty to sixty seconds is −0.65 nm/sec. It should be noted that those wafers with stable pattern sizes are excluded from the observations, such as when the resist is a hybrid-type resist corresponding to an exposure wavelength of 248 nm (KrF). Therefore, the ratio to be used for the PEB time correction coefficient for the first to fifth wafers is determined.

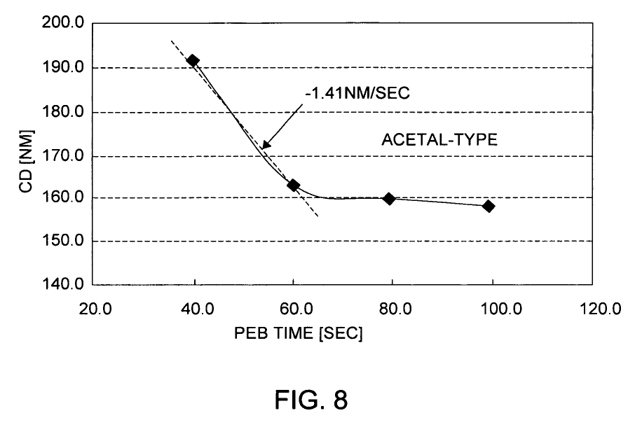

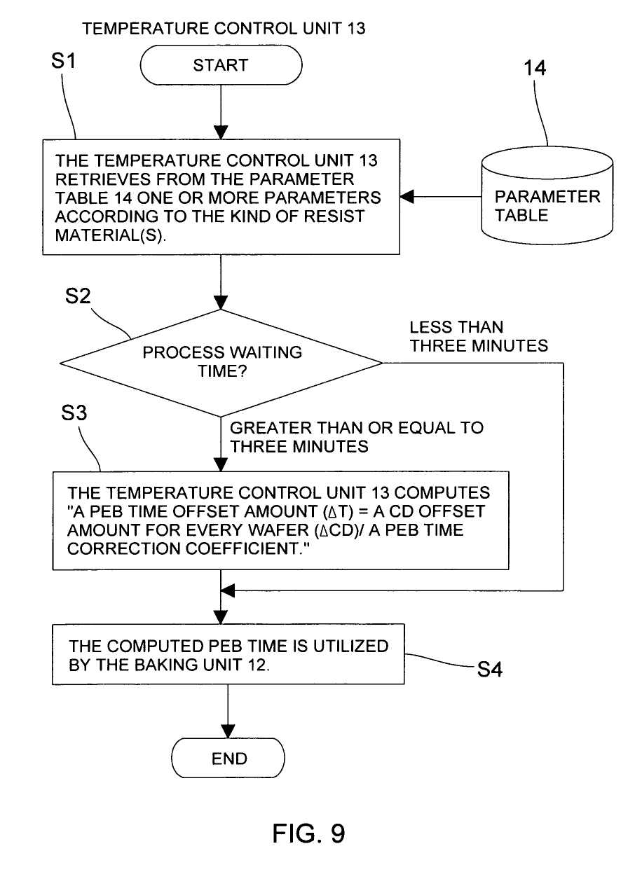

Similarly, referring to FIG. 7, in the case of an ESCAP type resist corresponding to an exposure wavelength of 248 nm (KrF), the PEB time correction coefficient is observed to be −0.45 nm/sec. Furthermore, referring to FIG. 8, in case of an acetal type resist, the PEB time correction coefficient is observed to be −1.41 nm/sec. In this manner, the relationship between pattern size and PEB time can be experimentally calculated for each type of resist material(s).

In reality, KrF resists sorted into the same hybrid type may have different PEB time correction coefficients in many cases. The reason for these different PEB time correction coefficients may result from the different type (structure) of acid generating agent or quenching reagent contained in the resist. Although resist materials are generally divided into three types (hybrid, ESCAP, and acetal), a generic or overall “coefficient” for each type is not determined because resist makers can respectively achieve independent performance by combining a plurality of acid generating agent and quenching reagent.

Referencing FIG. 6, an exemplary processing procedure for controlling the PEB apparatus 10 includes step SI of, first, responsive to an initial wafer of the plurality of wafers being carried into a PEB unit, the temperature control unit 13 retrieves from the parameter table 14 one or more parameters according to the kind of resist material(s). The retrieved parameter(s) include PEB temperature, an average PEB time, a PEB time correction coefficient, a ΔCD for every wafer, and an applicable condition.

Next, at step S2, the temperature control unit 13 determines whether the accrued process waiting time before inception of the batch sequence is or is not less than a threshold value (in this case, whether the accrued process waiting time is not less than three minutes). When the process waiting time is less than three minutes, the process advances to step S4, and in connection with a PEB time, an average PEB time is set in the baking unit 12 for all wafers of the batch sequence. Accordingly, if the accrued process waiting time is less than a threshold value, correction of the PED time does not occur and the process skips forward to step S4 where the baking unit uses the stock PEB time to carry out the batch process.

On the other hand, when the accrued process waiting time is greater or equal to the threshold value (in this case, three minutes), the temperature control unit 13 at step S3 computes a PEB time for every wafer using the PEB time correction coefficient and the ΔCD stored on the parameter table 14. Subsequently, the computed PEB time is utilized by the baking unit 12 in step S4 to carry out the batch process.

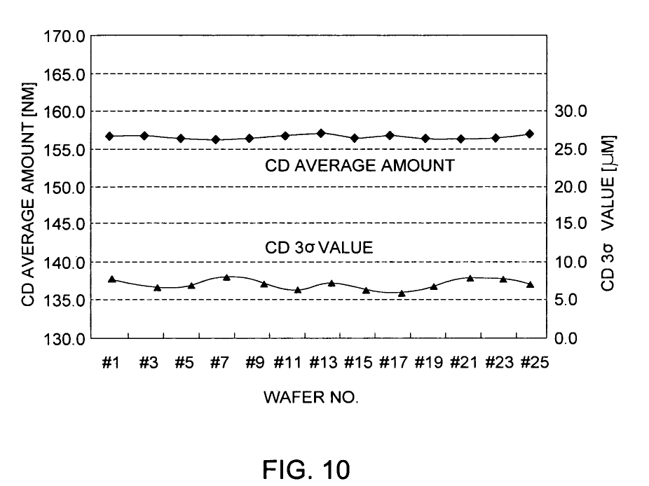

Referring to FIG. 10, observed pattern sizes obtained by executing the foregoing PEB time control method have been shown to greatly reduce pattern size variation. For example, it has been found that the pattern sizes for five initial wafers in a batch sequence is equal to or generally equal to the pattern size for the sixth and subsequent wafers in the batch process. Therefore, since the pattern sizes for all wafers processed in the batch sequence can be held substantially constant, the differences in characteristics caused by the fluctuation of pattern sizes between wafers can be reduced and thus the degradation of yield can be improved.

In the above-described embodiment, all the baking processes are automatically performed on the basis of the decision as to three facts: (1) whether the process waiting time of the PEB apparatus was less than, equal to, or greater than a predetermined threshold value; (2) what the PEB time should be according to the type of resist material(s) used; and, (3) the set PEB time.

Moreover, although resist materials corresponding to an exposure wavelength of 248 nm (KrF laser) have been described in the above-described embodiment, the present disclosure can be similarly applied to resist materials corresponding to exposure wavelengths between 193 nm (ArF laser) and 365 nm (i ray of mercurial light source). Moreover, although different PEB correction coefficients and ΔCD may be used for different types of resist materials, many of these variations may be captured by experimental measurements resulting in parameter tables for the particular resist materials.

Furthermore, although the control method according to the present disclosure has been described as a control method of the PEB apparatus that performs a baking process after exposure of resists in the above-described embodiment, the control method can also be utilized as a control method for various baking processes including a control method for performing a baking process after applying resist materials.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A post exposure bake apparatus that sequentially bakes a plurality of wafers, at least one of which carries a resist material and which is at least partially fabricated using a batch baking process, the apparatus comprising:
a baking apparatus;
a programmable controller in electrical communication with the baking apparatus, the programmable controller operative to determine a baking time offset amount for at least one of a plurality of wafers carrying a resist material in a batch sequence; and
an algorithm associated with the programmable controller for correcting a baking time of at least one of the plurality of wafers carrying the resist material in accordance with the baking time offset amount corresponding to a processing order number of the at least one of the plurality of wafers carrying the resist material when processing the plurality of wafers.

2. The post exposure bake apparatus according to claim 1, wherein:
the algorithm is operative to determine whether a process waiting time from a termination of a previous batch sequence to a present new batch sequence exceeds a predetermined threshold value each time the batch sequence is newly started; and
the algorithm stops correction for at least one of the plurality of wafers carrying the resist material in the new batch sequence when it is determined that the process waiting time does not exceed the predetermined threshold value.

3. The post exposure bake apparatus according to claim 2, further comprising:
a look-up table including baking time offset amounts correlated to a plurality of different resist materials;
wherein the controller is in electrical communication with the look-up table to extract a baking time offset amount specific to the kind of resist material applied to at least one of the plurality of wafers;
wherein the controller corrects the baking time in accordance with the baking time offset amount specific to the type of resist material applied to at least one of the plurality of wafers of the batch sequence.

4. The post exposure bake apparatus according to claim 2, wherein the baking time offset amount setting means comprises means for computing the baking time offset amount on the basis of a predetermined PEB time correction coefficient corresponding to the kind of resist materials of the batch sequence every new batch sequence.

5. A control method for an apparatus that sequentially bakes a plurality of semiconductor wafers of which at least one carries a resist material and at least partially fabricated using a batch baking process, the method comprising:
setting a baking time offset amount for at least the one semiconductor wafer carrying the resist material processed in the batch baking process; and
correcting a baking time of at least the one semiconductor wafer in accordance with the set baking time offset amount when baking the at least one semiconductor wafer.

6. The control method according to claim 5, further comprising:
deciding whether a process waiting time from the termination of a previous batch baking process to a new batch baking process exceeds a predetermined threshold value each time the batch backing process is newly started; and
wherein the act or correcting the backing time includes the act of stopping for the at least one semiconductor wafer in the new batch baking process when it is determined that the process waiting time does not exceed the predetermined threshold value.

7. The control method according to claim 6, wherein:
the act of setting the baking time offset amount includes the act of setting a baking time offset amount for a plurality of resist materials, and
the act of correcting the baking time includes correcting the baking time in accordance with a baking time offset amount corresponding specifically to at least one of the resist materials of the batch baking process.

8. The control method according to claim 6, wherein the act or setting the baking time offset amount comprises computing the baking time offset amount on the basis of a predetermined post exposure bake time correction coefficient corresponding specifically to at least one of the resist materials of the batch baking process for each new batch baking process.

9. A post exposure bake apparatus that sequentially processes a plurality of wafers, the apparatus comprising:
a baking time offset amount calculator that sets a baking time offset amount for a plurality of wafer batches processed in a series of batch baking processes; and
a baking time correction calculator calculating a baking time of each of the plurality of wafer batches in accordance with the baking time offset amount when the plurality of wafer batches are baked in the series of batch baking processes.

10. The post exposure bake apparatus according to claim 9, further comprising a processor for determining whether a process waiting time from the termination of a previous batch baking process to the inception of a subsequent batch baking process exceeds a predetermined threshold value; and
the baking time correction calculator inhibits correction for the subsequent batch baking process when the processor determines that the process waiting time does not exceed the predetermined threshold value.

11. The post exposure bake apparatus according to claim 10, wherein
the baking time offset amount calculator sets the baking time offset amount dependent upon the type of resist material applied to wafers of the plurality of wafer batches, and
the baking time correction calculator determines the baking time using the baking time offset amount corresponding to the type of resist material applied to wafers of the plurality of wafer batches.

12. The post exposure bake apparatus according to claim 10, wherein the baking time offset amount calculator includes a computer for computing the baking time offset amount on the basis of a predetermined post exposure bake time correction coefficient corresponding to the type of resist material applied to wafers of the plurality of wafer batches.

13. A control method in an apparatus that sequentially bakes a plurality of wafers of which each carries a resist material and which is at least partially fabricated in a batch sequence, the method comprising:
setting a baking time offset amount for a group of wafers comprising a batch set in the batch baking sequence; and
correcting a baking time of for the group of wafers in accordance with a baking time offset amount.

14. The control method according to claim 13, further comprising:
determining whether a process waiting time from the termination of a previous baking batch sequence to a subsequent batch baking sequence exceeds a predetermined threshold value; and
the baking time correcting step stops correction for the subsequent batch baking sequence when it is determined that the process waiting time does not exceed the predetermined threshold value.

15. The control method according to claim 14, wherein
the baking time offset amount setting step sets the baking time offset amount dependent upon a type of resist material coating the group of wafers of the batch set; and
the baking time correcting step corrects the baking time in accordance with a baking time offset amount corresponding to the type of resist material coating the group of wafers of the batch set.

16. The control method according to claim 14, wherein the baking time offset amount setting step comprises computing the baking time offset amount on the basis of a predetermined post exposure baking time correction coefficient corresponding to a type of resist material coating the group of wafers of the batch set.
